(19) United States
(12) Patent Application Publication
(10) Pub. No.: US 2009/0324021 A1
(43) Pub. Date: Dec. 31, 2009

(54) Method of Identification of a Person on the Iris of the Eye (Embodiments)

(76) Inventors: Dmitry Evgenievich Antonov, Moscow (RU); Ivan Vladimirovich Ogurechnikov, Moscow (RU)

Correspondence Address: COLLARD & ROE, P.C., 1077 NORTHERN BOULEVARD, ROSLYN, NY, 11576, US

(21) Appl. No.: 12/448,899

(22) PCT Filed: Apr. 16, 2007
(86) PCT No.: PCT/RU2007/000186

§ 371 Date: Jul. 14, 2009

(30) Foreign Application Priority Data
Jan. 15, 2007 (RU) 2007100649

(51) Int. Cl. G06K 9/00

(52) U.S. Cl. 382/117

(57) ABSTRACT

The present invention is aimed at improving accuracy of identifying a person. The above object has been achieved by the fact that a method of identification of a person on the iris thereof comprises recording of an iris color image and its further processing over several different spectral (color) ranges and forming an identification code with respect to each of these ranges; the fact of identification of a person being determined according to matching of identification codes over all spectral ranges to be processed. The above object has also been achieved by the fact that a method of identification of a person on the iris thereof comprises recording of an iris color image over several different spectral (color) ranges and its further processing over the same several different spectral ranges and forming an identification code with respect to each of these ranges; the fact of identification of a person being determined according to matching of identification codes over several or all spectral ranges.

### FIELD OF THE INVENTION

The present invention relates to the procedure for protecting various objects against access of unauthorized persons through identification of a person on an iris image thereof and may be used in diagnosis of the state of organs and functional systems of the organism using the iris.

### BACKGROUND OF THE INVENTION

There has been known a method of identification of a person on an iris image thereof comprising recording iris images of human beings and forming on their basis a database to be subsequently used for identification of a person. Each image, before inputting in a database, is processed in a computer by means of special software and stored in the form of a certain data set. To perform the process of identification of a person, recording of an image of its iris is carried out; the image so recorded is processed and compared with those stored in the database (see, WO 03/049010).

The drawback to the known method resides in its relatively low accuracy, since for identification of a person use is made of one set of characteristic features, that is to say of one code.

There has been known a method of identification of a person on an iris image thereof comprising recording iris images of human beings and forming on their basis a database to be subsequently used for identification of a person. In the process for recording an iris image, the eye of a person is illuminated by optical emission over a narrow spectral range. Semiconductor emission sources are used as a source of such illumination. Each image, before inputting in a database, is processed in a computer by means of special software and stored in the form of a certain code. To perform the process of identification of a person, recording of an image of its iris is carried out; the image so recorded is processed and compared with those stored in the database (see, JP10137220).

The drawback to the known method resides in its relatively low accuracy, since for identification of a person use is made of one set of characteristic features, that is to say of one code.

The closest prior art with respect to the present invention has been disclosed in a method of identification of a person on the iris thereof, that consists in the following. It has been established that the use of an illumination in one spectral range, due to differences in the iris pigment coloring, in a number of cases makes it difficult to discriminate the boundary between white eye and iris; besides, a part of the iris characteristic features is not revealed due to a weak contrast range when using an illumination with a wavelength close to the color of these elements. Therefore in the known method, the eye of a person to be identified is first illuminated with the light which is close to infrared, then an iris pigment color is revealed, and on this basis there is isolated a wavelength of an optical emission source to be used for illuminating the iris at the moment of recording its image. As a result of processing the image, a corresponding code is formed and stored in a database for comparison with a current value of the code to be created in a repeated recording of the iris image of a person to be identified (see, JP2006031185).

The drawback to the known method of identification of a person, despite the fact that codes to be obtained carry information about large quantities of characteristic elements, resides in its relatively low accuracy, since for identification of a person use is made of one set of characteristic features, that is to say of one code.

### SUMMARY OF THE INVENTION

It is an object of the present invention to improve identification accuracy.

The above object has been achieved by the fact that a method of identification of a person on the iris thereof comprises recording of an iris color image and its further processing over several different spectral (color) ranges and forming an identification code with respect to each of these ranges; in so doing, the fact of identification of a person being determined according to matching of identification codes over all spectral ranges to be processed.

The above object has also been achieved by the fact that in the process of recording, the iris is illuminated by optical emission having a spectral range close to achromatic light.

The above object has also been achieved by the fact that illuminating emission is concentrated in the region of a recording system focus.

The above object has also been achieved by the fact that illuminating emission is concentrated on an image to be obtained maximally inside the pupilary zone.

The above object has also been achieved by the fact that illuminating emission is intensity modulated.

The above object has also been achieved by the fact that a method of identification of a person on the iris thereof comprises recording of an iris color image over several different spectral (color) ranges and its further processing over the same several different spectral ranges and forming an identification code with respect to each of these ranges; in so doing, the fact of identification of a person being determined according to matching of identification codes over several or all spectral ranges.

The above object has also been achieved by the fact that in the process of recording the iris over each of spectral ranges, it is illuminated by optical emission having a spectral range compatible with the spectral range of recording.

The above object has also been achieved by the fact that illuminating emission is concentrated in the region of a recording system focus.

The above object has also been achieved by the fact that illuminating emission is concentrated on an image to be obtained maximally inside the pupilary zone.

The above object has also been achieved by the fact that illuminating emission over at least one of spectral ranges is intensity modulated.

### BEST MODES FOR CARRYING OUT THE INVENTION

Recording of an iris color image and its further processing over several different spectral ranges enable one to obtain several images of one and the same iris in which characteristic points (image elements) will have different location in one and the same coordinate grid. In doing so, those characteristic features that have a low contrast in one color spectrum and/or when illuminating by emission of the same wavelength may be ignored by the image recognition and processing system, turn out to be more contrast in another color spectrum and/or when illuminating by emission of the corresponding another wavelength. This, in turn, affords formation of identification codes with respect to each of images, with each code being strictly individual and belonging to that person only. Therefore identification which is carried out with respect to several codes at once, improves accuracy of the person identification multiply, since a person is considered to be identified unambiguously when all codes obtained in the processing of several images match.

The use, in the process of iris recording, of illumination by optical emission having a spectral range close to achromatic light improves identification accuracy, since on the one hand it makes it possible to obtain an iris color image with spectral characteristics of its elements essentially undistorted, and on the other hand it affords isolation of a reasonably large number of spectra (or spectral lines, or spectral ranges) in which processing of this image is possible.

It is most expeditious to concentrate illuminating emission in the region of a recording system focus, since in this case the use of an illumination system will be most efficient with its energy consumption tending to minimum. This also improves identification accuracy, since it is possible to make use of it as a system of an iris visual positioning to the region of a system recording.

It is also possible to improve a person identification accuracy by the fact that illuminating emission is concentrated on an image to be obtained maximally inside the pupilary zone, since this makes it possible to obtain an iris image with minimal luminous artifacts on the usable area of an iris image to be obtained.

Moreover, if illuminating emission is intensity modulated, it is possible to reveal whether a person to be identified makes use of contact lenses and/or whether an eye whose image is analyzed belongs not to a living human being but to a moulage or dead body.

According to the present invention a second method of identification of a person, like a first one, makes it possible to improve identification accuracy and is based on a similar principle, namely: it provides for the formation of several identification codes and identification of a person where all these codes match. Whereas in the first method one color image is recorded and then processed over different spectral ranges, in the second method several images are recorded and then processed over several spectral ranges.

In order to further improve identification accuracy using several codes, it is advisable that in the process of recording the iris over each of spectral ranges the iris be illuminated by optical emission having a spectral range compatible with the spectral range of recording. In this case improvements in accuracy are achieved not only by availability of codes according to identification of a color of the iris image so obtained but also by spectral components revealed by means of illumination features, said components being characteristic of different iris type (brown, grey or mixed type).

In the same manner as with the first method, it is expeditious to concentrate illuminating emission in the region of a recording system focus, since in this case the use of an illumination system will be most efficient with its energy consumption tending to minimum. This also improves identification accuracy, since it is possible to make use of it as a system of an iris visual positioning to the region of a system recording.

Whereas in the first method the entire flux of illuminating emission is intensity modulated, since it is the only flux, in the second method, having regard to the fact that several iris images are recorded in succession over different spectral ranges and illumination is carried out by optical emission of various ranges, it is possible to modulate emission of only one spectral range or modulate a combination of several different emission ranges. The first consideration consists in that a response of the pupilary zone to a modulated change in intensity of the iris illumination emission should be the most maximal and efficient.

The essence of the claimed methods is explained by their embodiments.

### Example 1

In the most general case, a first method as characterized in Claim 1 is carried out as follows. An individual to be identified is located in a visual field of recording means that enables a high-quality color image to be obtained. Such means may be used in the form of a color TV video-camera with a digital output or a digital photographic camera that allows taking photographs at low, about 0.001 sec, time intervals. The image so obtained is digitized and transmitted to a personal computer equipped with relevant software (see, WO 03/053123). In accordance with the known image processing program the computer forms several monochrome images from a registered color image and isolates features of each image to be analyzed. On the basis of isolation and analysis of the iris images, codes of each of these images are formed and stored in a database as template codes. Subsequently, when problem of identifying a person arises in order to permit access or passage, e.g. to a secured location, any storage, or in case of crossing the border of the State, a procedure described above is repeated, except that codes obtained during this identification are compared to those previously stored in a database, and in case of complete matching of all codes an identified person is allowed access or passage.

### Example 2

In a particular case, the first method may be carried out as follows. An individual to be identified is located in a visual field of recording means that enables a high-quality color image to be obtained. Such means may be used in the form of a color TV video-camera with a digital output or a digital photographic camera that allows taking photographs at low, about 0.001 sec, time intervals. In the process of recording the iris image it is illuminated by optical emission having a spectral range close to achromatic light. To this end use may be made of the known emission sources, for example super-bright light-emitting diodes of a certain luminescence range or other sources. Since illumination is optimal where emission concentrates on the one hand in the region of a recording system focus, and on the other hand on an image to be obtained maximally inside the pupilary zone, illumination means should be located in close proximity to the region covered by recording but stay out of this region, wherever possible. The image so obtained is digitized and transmitted to a personal computer equipped with relevant software (see, e.g.—PrivateID® from Iridian Technologies is an image processing protocol and data standard that enables a Proof Positive-certified iris camera to capture an image, process it and prepare it for transport in the most secure way possible. Iris recognition is the most accurate, non-invasive and easy to use biometric for secure identification. http://www.iridiantech.com/products.php?page=1, or WO 03/053123). In accordance with the known image processing program the computer forms several monochrome images from a registered color image and isolates features of each image to be analyzed. On the basis of isolation and analysis of the iris images, codes of each of these images are formed and stored in a database as template codes. Subsequently, when problem of identifying a person arises in order to permit access or passage, e.g. to a secured location, any storage, or in case of crossing the border of the State, a procedure described above is repeated, except that codes obtained during this identification are compared to those previously stored in a database, and in case of complete matching of all codes an identified person is allowed access or passage.

### Example 3

In yet another particular case that affords accomplishment of the result at its maximum, the first method may be carried out as follows. An individual to be identified is located in a visual field of recording means that enables a high-quality color image to be obtained. Such means may be used in the form of a color TV video-camera with a digital output or a digital photographic camera that allows taking photographs at low, about 0.001 sec, time intervals. In the process of recording the iris image it is illuminated by optical emission having a spectral range close to achromatic light. To this end use may be made of the known emission sources, for example super-bright light-emitting diodes of a certain luminescence range or other sources. Since illumination is optimal where emission concentrates on the one hand in the region of a recording system focus, and on the other hand on an image to be obtained maximally inside the pupilary zone, illumination means should be located in close proximity to the region covered by recording. The image so obtained is digitized and transmitted to a personal computer equipped with relevant software (http://www.iridiantech.com/products.php?page=1). In accordance with the known image processing program the computer forms several monochrome images from a registered color image and isolates features of each image to be analyzed. On the basis of isolation and analysis of the iris images, codes of each of these images are formed and stored in a database as template codes. Subsequently, when problem of identifying a person arises in order to permit access or passage, e.g. to a secured location, any storage, or in case of crossing the border of the State, a procedure described above is repeated, except that codes obtained during this identification are compared to those previously stored in a database, and in case of complete matching of all codes an identified person may be allowed access or passage. But before granting such permission, it is necessary to ensure that the iris image has been obtained from the eyes of a living human being, not from his moulage. To this end, an illuminating emission is intensity modulated, and an image recording system monitors a pupil response to modulation, for which purpose an exposure time is slightly increased.

### Example 4

In one of the embodiments the first method was carried out as follows. An individual to be identified was located in a visual field of a color TV video-camera (for example, Sanyo VCC-6592P) with an analog output which, via a conversion unit, converts a signal to a digital output connected to a personal computer input. In the process of recording the iris image it was illuminated by optical emission having a spectral range close to achromatic light. To this end use was made of necessary light sources. Emission sources were located in close proximity to the region covered by recording such that emission concentrated on the one hand in the region of a recording system focus, and on the other hand on an image to be obtained maximally inside the pupilary zone. The image so obtained was digitized by the conversion unit and transmitted to a personal computer equipped with software enabling processing of the image obtained by isolating the required spectra (in a RGB space it is possible to isolate red, green and blue main color spectra and also possible to isolate, using software, additional color spectra from the main image, i.e. instead of one iris color image of a person to be identified it is possible to obtain three main monochrome images in red, green and blue color spectra and several additional monochrome images, e.g. in yellow and sky-blue spectra which enable the most accurate characterization of the iris color and detection of the greatest amount of individual features of this iris in different color spectra). As a result of image processing, the computer formed three monochrome images, i.e. red, blue and green images, from a registered color image and isolated features of each image to be analyzed. On the basis of isolation and analysis of the iris images, codes of each of these images were formed and stored in a database as template codes. To check the performance of the method, a person to be identified was repeatedly subjected to the procedure described above. On the completion of the procedure, the obtained codes were compared to those previously stored in a database, thus resulting in a complete matching of all three codes.

### Example 5

In one of the embodiments the first method was carried out as follows. An individual to be identified was located in a visual field of a color TV video-camera (for example, Sanyo VCC-6592P) with an analog output which, via a conversion unit, converts a signal to a digital output connected to a personal computer input. In the process of recording the iris image it was illuminated by optical emission having a spectral range close to achromatic light. To this end use was made of the so called super-bright emission sources (e.g. Aπ171 B3). Emission sources were located in close proximity to the region covered by recording such that they stayed out of this region and such that emission concentrated on the one hand in the region of a recording system focus, and on the other hand on an image to be obtained maximally inside the pupilary zone. The image so obtained was digitized by the conversion unit and transmitted to a personal computer equipped with software enabling isolation from data so obtained of necessary spectral components taking part in identification. As a result of image processing, the computer formed three monochrome images, i.e. red, blue and green images, from a registered color image and isolated features of each image to be analyzed. On the basis of isolation and analysis of the iris images, codes of each of these images were formed and stored in a database as template codes. To check performance of the method, a person to be identified was repeatedly subjected to the procedure described above. On the completion of the procedure, the obtained codes were compared to those previously stored in a database, thus resulting in a complete matching of all three codes. This means that an identified person may be allowed access or passage, e.g. to a secured location. But before granting such permission, it is necessary to ensure that the iris image has been obtained from the eyes of a living human being, not from his moulage. To check the efficiency of the method, a color photograph of a person to be identified was taken. Since to this end it is necessary that illuminating emission be intensity modulated, two experiments were conducted: in one case, in a visual field there was located a person to be identified and in another case—a moulage of his eye. In the process of recording the both images, the eye and moulage were illuminated by an intensity modulated emission with a variable frequency that was selected subject to a response of the pupil to the given frequency of exposure. In this case it amounted to ˜20 Hz for a time interval of no more than 1 sec. To this end, a value of the feeding current supplied to super-bright light-emitting diodes was modified. An image recorded by a TV camera on a continuous basis was transmitted to a computer whose image processing program enabled recording of a pupil diameter variation. As a result, where a living human being image was recorded, a signal confirming this fact was displayed on a computer monitor. Where a moulage was located in the visual field of a TV camera, the computer revealed this fact and generated a signal inhibiting passage to a secured location.

### Example 6

In the most general case, a second method as characterized in Claim 6 is carried out as follows. An individual to be identified is located in a visual field of recording means that enables a high-quality color image to be obtained. Such means may be used in the form of a color TV video-camera with a digital output or a digital photographic camera that allows taking photographs at low, about 0.001 sec, time intervals. The eye of a person to be identified is located in a visual field of recording means and the iris is recorded successively in a particular color—brown, red, yellow, orange, green, blue etc. The images so obtained are digitized and transmitted to a personal computer equipped with relevant software. Based on the analysis of the iris monochrome images, codes of each of these images are formed and stored in a database as template codes. Subsequently, when problem of identifying a person arises in order to permit access or passage, e.g. to a secured location, any storage, or in case of crossing the border of the State, a procedure described above is repeated, except that codes obtained during this identification are compared to those previously stored in a database, and in case of complete matching of all codes an identified person is allowed access or passage.

### Example 7

In a particular case, the second method may be carried out as follows. An individual to be identified is located in a visual field of recording means that enables a high-quality color image to be obtained. Such means may be used in the form of a color TV video-camera with a digital output or a digital photographic camera that allows taking photographs at low, about 0.001 sec, time intervals. The eye of a person to be identified is located in a visual field of recording means and is illuminated successively by optical emission with different wavelengths which could correspond to particular colors—brown, red, yellow, orange, green, blue etc. Using recording means and a computer, there are recorded several iris images each illuminated at the moment of recording by optical emission of a certain color. The images so obtained are digitized and transmitted to a personal computer equipped with relevant software. Based on the analysis of the iris monochrome images, codes of each of these images are formed and stored in a database as template codes. To illuminate the eye at the moment of recording its monochrome images, use may be made of the known emission sources, for example various light-emitting diodes or emission sources with relevant filters. Since illumination is optimal where emission concentrates on the one hand in the region of a recording system focus, and on the other hand on an image to be obtained maximally inside the pupilary zone, illumination means should be located in close proximity to the region covered by recording but stay out of this region, wherever possible. In accordance with the known image processing program the computer analyzes several monochrome images so obtained and isolates features of each image to be analyzed. On the basis of isolation and analysis of the iris images, codes of each of these images are formed and stored in a database as template codes. Subsequently, when problem of identifying a person arises in order to permit access or passage, e.g. to a secured location, any storage, or in case of crossing the border of the State, a procedure described above is repeated, except that codes obtained during this identification are compared to those previously stored in a database, and in case of complete matching of all codes an identified person is allowed access or passage.

### Example 8

In yet another particular case that affords accomplishment of the result at its maximum, the second method may be carried out as follows. An individual to be identified is located in a visual field of recording means that enables a high-quality color image to be obtained. Such means may be used in the form of a color TV video-camera with a digital output or a digital photographic camera that allows taking photographs at low, about 0.001 sec, time intervals. The eye of a person to be identified is located in a visual field of recording means and is illuminated successively by optical emission with different wavelengths which could correspond to particular colors—brown, red, yellow, orange, green, blue etc. Using recording means and a computer, there are recorded several iris images each illuminated at the moment of recording by optical emission of a certain color. The images so obtained are digitized and transmitted to a personal computer equipped with relevant software. Based on the analysis of the iris monochrome images, codes of each of these images are formed and stored in a database as template codes. To illuminate the eye at the moment of recording its monochrome images, use may be made of the known emission sources, for example various light-emitting diodes or emission sources with relevant filters. Since illumination is optimal where emission concentrates on the one hand in the region of a recording system focus, and on the other hand on an image to be obtained maximally inside the pupilary zone, illumination means should be located in close proximity to the region covered by recording. On the basis of isolation and analysis of the iris monochrome images, codes of each of these images are formed and stored in a database as template codes. Subsequently, when problem of identifying a person arises in order to permit access or passage, e.g. to a secured location, any storage, or in case of crossing the border of the State, a procedure described above is repeated, except that codes obtained during this identification are compared to those previously stored in a database, and in case of complete matching of all codes an identified person may be allowed access or passage. But before granting such permission, it is necessary to ensure that the iris image has been obtained from the eyes of a living human being, not from his moulage. To this end, an illuminating emission, at least over one of spectral ranges (color), is intensity modulated, and an image recording system monitors a pupil response to modulation, for which purpose an exposure time is slightly increased.

### Example 9

In one of the embodiments the second method was carried out as follows. An individual to be identified was located in a visual field of a color TV video-camera with a digital output after signal conversion, said output being connected to a personal computer input. The eye of a person to be identified located in a visual field of recording means was illuminated successively by optical emission with different wavelengths which corresponded to particular colors—red, green, blue. Accordingly, using recording means and a computer connected thereto, these three iris images were recorded, each being illuminated at the moment of recording by optical emission of the color with which the recording was carried out. To this end, use was made of emission sources (super-bright light-emitting diodes for the red illumination spectrum—BSOL445-1HGB, for the blue illumination spectrum—BB445-1F and for the green illumination spectrum—BGD1445-1L5). The emission sources were located along the circumference in close proximity to the region covered by recording such that they stayed out of this region and such that emission of all illumination sources concentrated on the one hand in the region of a recording system focus, and on the other hand on an image to be obtained maximally inside the pupilary zone. The image so obtained was digitized by the vide camera itself and transmitted to a personal computer equipped with software enabling computer analysis of several monochrome images so obtained and isolation of features of each image to be analyzed.

As a result of processing three monochrome images—red, green and blue, the computer isolated features of each image to be analyzed. On the basis of isolation and analysis of the iris images, codes of each of these images were formed and stored in a database as template codes. To check performance of the method, a person to be identified was repeatedly subjected to the procedure described above. On the completion of the procedure, the obtained codes were compared to those previously stored in a database, thus resulting in a complete matching of all three codes. This means that an identified person may be allowed access or passage, e.g. to a secured location.

But before granting such permission, it is necessary to ensure that the iris image has been obtained from the eyes of a living human being, not from his moulage. To check the efficiency of the method, a color photograph of a person to be identified was taken. Since to this end it is necessary that illuminating emission be intensity modulated, two experiments were conducted: in one case, in a visual field there was located a person to be identified and in another case—a moulage of his eye. In the process of recording the both images, the eye and moulage were illuminated by an intensity modulated emission of blue and green colors simultaneously. To this end, a value of the feeding current supplied to light-emitting diodes of corresponding color was modified (for the blue illumination spectrum—BB445-1F and for the green illumination spectrum—BGD1445-1L5). An image recorded by a TV camera on a continuous basis was transmitted to a computer whose image processing program enabled recording of a pupil diameter variation. As a result, where a living human being image was recorded, a signal confirming this fact was displayed on a computer monitor. Where a moulage was located in the visual field of a TV camera, the computer revealed this fact and generated a signal inhibiting passage to a secured location.

1. A method of identification of a person on the iris thereof comprising recording of an iris color image and its further processing over several different spectral ranges and forming an identification code with respect to each of these ranges; the fact of identification of a person being determined according to matching of identification codes over all spectral ranges to be processed.

2. A method as defined in claim 1, wherein in the process of recording, the iris is illuminated by optical emission having a spectral range close to achromatic light.

3. A method as defined in claim 2, wherein illuminating emission is concentrated in the region of a recording system focus.

4. A method as defined in claim 2, wherein illuminating emission is concentrated on an image to be obtained maximally inside the pupilary zone.

5. A method as defined in claim 2, wherein illuminating emission is intensity modulated.

6. A method of identification of a person on the iris thereof comprising recording of an iris color image over several different spectral ranges and its further processing over the same several different spectral ranges and forming an identification code with respect to each of these ranges; the fact of identification of a person being determined according to matching of identification codes over several or all spectral ranges.

7. A method as defined in claim 6, wherein in the process of recording the iris over each of spectral ranges, it is illuminated by optical emission having a spectral range compatible with the spectral range of recording.

8. A method as defined in claim 7, wherein illuminating emission is concentrated in the region of a recording system focus.

9. A method as defined in claim 7, wherein illuminating emission is concentrated on an image to be obtained maximally inside the pupilary zone.

10. A method as defined in claim 7, wherein illuminating emission over at least one of spectral ranges is intensity modulated.
